(19) United States
(12) Patent Application Publication
(10) Pub. No.: US 2010/0229836 A1
(43) Pub. Date: Sep. 16, 2010

(54) GUIDED BRIDGE FOR A PISTON IN AN INTERNAL COMBUSTION ENGINE

(75) Inventors: Peter Hofbauer, West Bloomfield, MI (US); Adrian N. Tusinean, Windsor (CA); Chou Lee, Warren, MI (US)

Correspondence Address: PAUL K. GODWIN;Paul K. Godwin, P.C., 7218 Pine Vista Dr., Brighton, MI, 48116, US

(73) Assignee: EcoMotors International, Inc., Troy, MI (US)

(21) Appl. No.: 12/723,418

(22) Filed: Mar. 12, 2010

Related U.S. Application Data
(60) Provisional application No. 61/209,904, filed on Mar. 12, 2009.

(51) Int. Cl. F02B 75/28; F02F 3/00

(52) U.S. Cl. 123/51 R; 123/193.4

(57) ABSTRACT

An improved configuration for internal combustion engine that reduces side forces on pistons during the engine cycle. The improvement is an intermediate and guided bridge element located between pull rods and pistons with articulated connections that allow side forces to be dissipated away from the pistons.

### RELATED APPLICATIONS

This application claims priority benefit of provisional application Ser. No. 61/209,904, filed Mar. 12, 2009.

### TECHNICAL FIELD

This invention is related to the field of internal combustion engines and more specifically to improvements in such engines configured with opposing cylinders and opposing pistons in each cylinder (“OPOC engine”).

### BACKGROUND

This invention involves improvements to internal combustion engines and in particular OPOC engines of the type described and claimed in earlier U.S. Pat. Nos. 6,170,443, and 7,434,550, which are incorporated herein by reference. Other types of OPOC engines having one or more crankshafts, also can benefit from the present invention.

As background, the OPOC engine from U.S. Pat. No. 6,170,443 is shown in FIGS. 1 and 2. In those figures, the engine configuration is shown to comprise a left cylinder 100 (1100 FIG. 2), a right cylinder 200 (1200), and a single central crankshaft 300 (1300) located between the cylinders. The left cylinder 100 has an outer piston 110 and an inner piston 120, with combustion faces 111 and 121 respectively, the two pistons forming a combustion chamber 150 between them. The right cylinder 200 similarly has an outer piston 210, an inner piston 220, with combustion faces 211 and 221 and combustion chamber 250. Each of the four pistons 110, 120, 210, and 220 are connected to a separate eccentric on the crankshaft 300 (1300).

The inner piston 120 of the left cylinder 100 is connected to crankshaft eccentric 312 by means of pushrod 412; the inner piston 220 of the right cylinder 200 is similarly connected to crankshaft eccentric 322 by pushrod 422. During normal engine operation, pushrods 412 and 422 are always under compression. The pushrods have concave ends 413 and 423 which ride on convex cylindrical surfaces 125 and 225 on the rear of the inner pistons.

The outer piston 110 of the left cylinder 100 (1100) is connected to crankshaft eccentric 311 by means of pullrod 411 (1411); the outer piston 210 of the right cylinder 200 (1200) is similarly connected to crankshaft eccentric 321 by pullrod 421 (1421). During normal engine operation, pullrod s 411 (1411) and 421 (1421) are always under tension. While single pullrods are shown on the near side in FIGS. 1 and 2, it should be understood that pairs of pullrods are used, with one pullrod on the near side of each cylinder and one on the far side of each cylinder. The near and far side pullrods connect to separate crankshaft journals having the same angular and offset geometries. The pullrods 411 (1411) and 421 (1421) communicate with the outer pistons by means of pins 114 (1114) and 214 (1214) that pass through slots (1115) and (1215) in the cylinder walls

The four pistons 110, 120, 210, and 220 have a plurality of piston rings 112, 122, 212, and 222, respectively, located behind the combustion faces. Additional piston rings may be added to the piston skirts, as may be required to reduce wear and control lubrication oil distribution. The cylinders 100 and 200 each have intake, exhaust, and fuel injection ports. On the left cylinder 100, the outer piston 110 opens and closes intake ports 161 (intake piston) and the inner piston 120 opens and closes exhaust ports 163 (exhaust piston). Fuel injection port 162 is located near the center of the cylinder. On the right cylinder 200, the inner piston 220 opens and closes intake ports 261 and the outer piston opens and closes exhaust ports 263. Again, fuel injection port 262 is located near the center of the cylinder. The asymmetric arrangement of the exhaust and intake ports on the two cylinders serves to help dynamically balance the engine, as described below.

Each of the four crankshaft eccentrics 311, 312, 321, and 322 are positioned with respect to the crankshaft rotational axis 310. The eccentrics for the inner pistons 312, 322 are further from the crankshaft rotational axis than the eccentrics for the outer pistons 311, 321, resulting in greater travel for the inner pistons than for the outer pistons. The eccentrics for the inner left piston 312 and the outer right piston 321, the pistons which open and close the exhaust ports in the two cylinders, are angularly advanced, while the eccentrics for the outer left piston 311 and inner right piston 322 are angularly retarded (note that the direction of crankshaft rotation is counterclockwise, as indicated by the arrow in FIG. 1).

As further shown in FIGS. 1 and 2, each cylinder is supercharged. Supercharging improves scavenging, improves engine performance at low rpms and recovers energy from the engine exhaust.

As mentioned above, the pullrods are always under tension forces Fᵣ that are communicated to and from the piston (via piston pins) as compression forces Fₚ. During the times that the pullrods are at an angle with respect to the reciprocating axis of the outer pistons, there are minor side force components Fₛ generated at the outer piston pins 114 (1114) and 214 (1214). These side forces occur during both the power and compression strokes of the engine cycle and are directed towards the cylinder walls. Several efforts have been made to minimize the effects of such side forces, including increasing the lubrication between the cylinder wall and the piston skirt; providing more piston rings along the piston skirt; and reducing the length of the piston skirt. However, each conventional attempt to reduce the effects of pullrod side forces has resulted in other undesirable effects.

### SUMMARY OF THE INVENTION

The present invention provides reduction in the side forces attributed to pullrod connections to the outer pistons of an OPOC engine by providing an intermediate bridge member between the pullrods and the outer piston to dissipate the side forces and isolate them from reaching the outer piston.

The present invention provides reduction in the side forces attributed to pullrod connections to the outer pistons of an OPOC engine by providing an intermediate bridge member with articulated low friction connections to the pullrods and the outer piston.

The present invention provides reduction in the side forces attributed to pullrod connections to the outer pistons of the OPOC engine by providing an extension to the cylinder housing with a pair of elongated side openings with lubricated guide edge bearing surfaces for allowing an intermediate bridge member between the pullrods and the outer pistons to slide there-along during engine operation to dissipate the side forces and isolate them from reaching the outer piston.

The present invention provides reduction in the side forces attributed to pullrod connections to the outer pistons of the OPOC engine by providing a low friction and rotatable bearing connection between the pullrods and the intermediate bridge member that is located between the pullrods and the outer piston.

The present invention provides reduction in the side forces attributed to pullrod connections to the outer pistons of the OPOC engine by providing a ball joint connection between the intermediate bridge member and the outer piston.

Two embodiments of the intermediate bridge element are shown. In a first embodiment, the bridge element contains a pair of upper and lower wear pads that contact the lubricated guide edge bearing surfaces provided by the extension to the cylinder housing. In a second embodiment, the upper and lower surfaces of the intermediate bridge element are used to directly contact and slide along the lubricated guide edge bearing surfaces provided by the extension to the cylinder housing.

It is an object of the present invention to provide an improved OPOC engine with reduced friction and increased efficiencies by eliminating side forces on the outer pistons during the engine cycle.

It is another object of the present invention to provide an improved OPOC engine in which the connections between the outer pistons and their associated pull rods do not allow the communication of off-axis side forces to either element.

### BRIEF DESCRIPTION OF THE DRAWINGS

FIG. 1 is a cross-sectional concept view depicting the operative elements of a prior art OPOC engine configuration and is discussed above.

FIG. 2 is a plan view of a physical embodiment of the same prior art OPOC engine shown in FIG. 1.

FIG. 3 is a cut-away perspective view of an OPOC engine containing the improvements of the present invention.

FIG. 4 is a perspective view of the OPOC engine shown in FIG. 3 with one end cut-away to illustrate the present invention.

FIG. 5 is a cross-sectional illustration of an embodiment of the present invention taken along lines 5-5 in FIG. 4.

FIG. 6 is an enlarged view of a portion of the OPOC engine shown in FIG. 4, containing an embodiment of the present invention.

FIG. 8 is a partial cross-sectional view taken along section line 8-8 in FIG. 6.

FIG. 9 is an enlarged top plan view of the pull rod bridge element of the present invention.

FIG. 10 is a top plan view of an embodiment of the guided bridge connected between pull rods and the outer piston of an OPOC engine.

FIG. 11 is a perspective view of the underside of a first embodiment of an OPOC engine outer piston configured to mate with the guided bridge shown in FIGS. 9 and 10.

FIG. 12 is a perspective view of the underside of a second embodiment of an OPOC engine outer piston configured to mate with the guided bridge shown in FIGS. 9 and 10.

FIG. 13 is a perspective partial cross-sectional view of a bridge assembly the present embodiment mated with a second embodiment of the outer piston shown in FIG. 12.

FIGS. 14 and 15 are vector graphs showing the possible effects of conflicting forces on embodiments of the present invention with and without spherical joints between the pull rods and the bridge element.

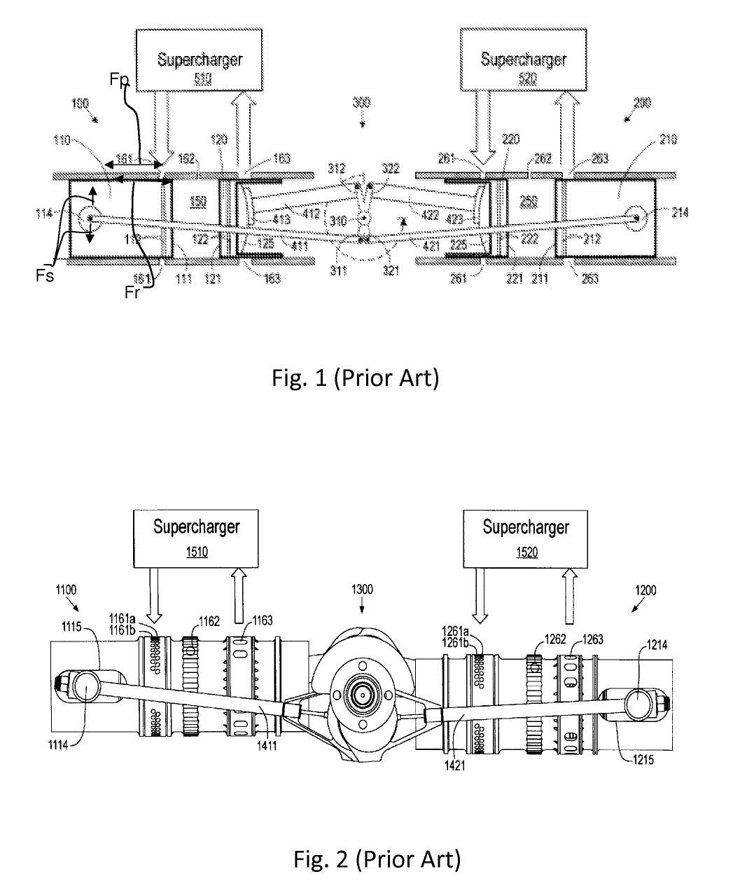

### DETAILED DESCRIPTION OF THE INVENTION

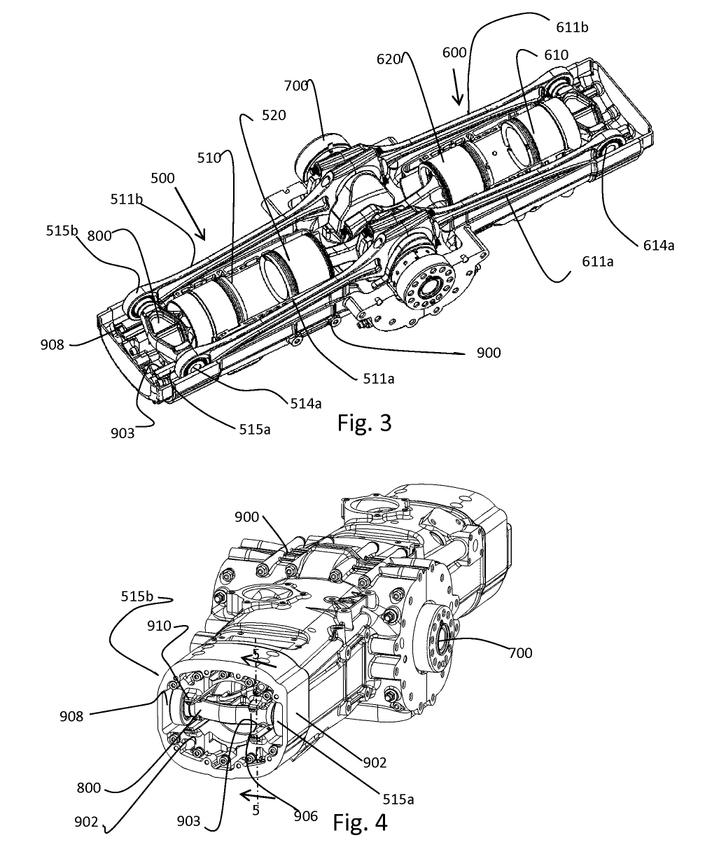

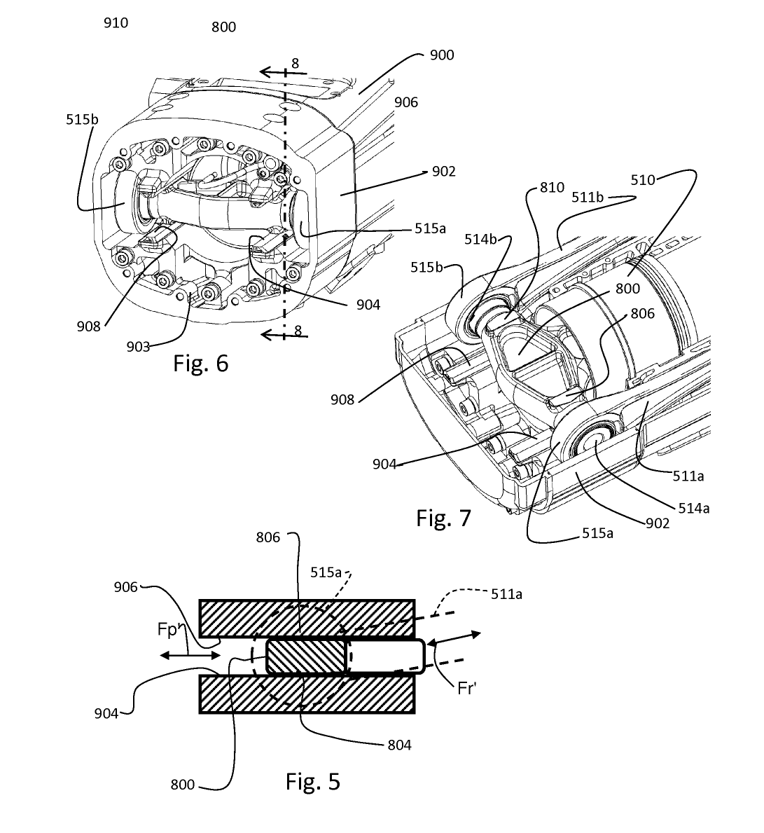

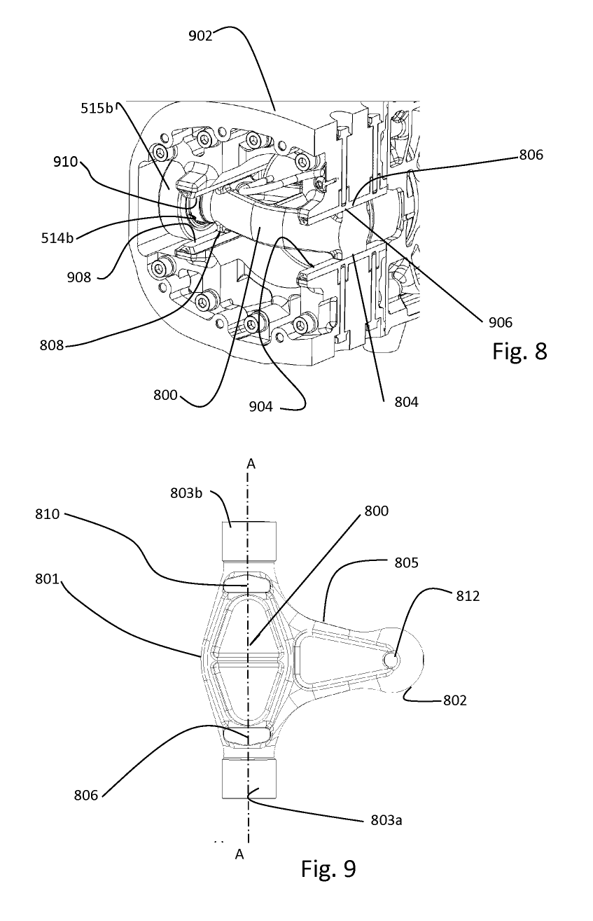

The present invention is shown in FIGS. 3-13, in conjunction with an OPOC engine of the type described above and incorporated herein by reference. In FIG. 3, an OPOC engine is shown as having a left cylinder 500, a right cylinder 600 in a housing 900 and a common crankshaft 700. Left cylinder 500 has an outer piston 510 and an inner piston 520. Opposing right cylinder 600 has an outer piston 610 and an inner piston 620. Outer piston 510 is connected to crankshaft 700 via a pair of pull rods 511a and 511b. Outer piston 610 is connected to the crankshaft 700 via a pair of pull rods 611a and 611b.

The improvement over the prior art OPOC engine described above results from the use of a guided bridge 800 that is located between the outer piston 510 and the pullrods 511a and 511b. (Although the following discussion is directed to the left cylinder 500, it should be understood that the right cylinder is identically configured to provide identical improvements to the engine as a whole.)

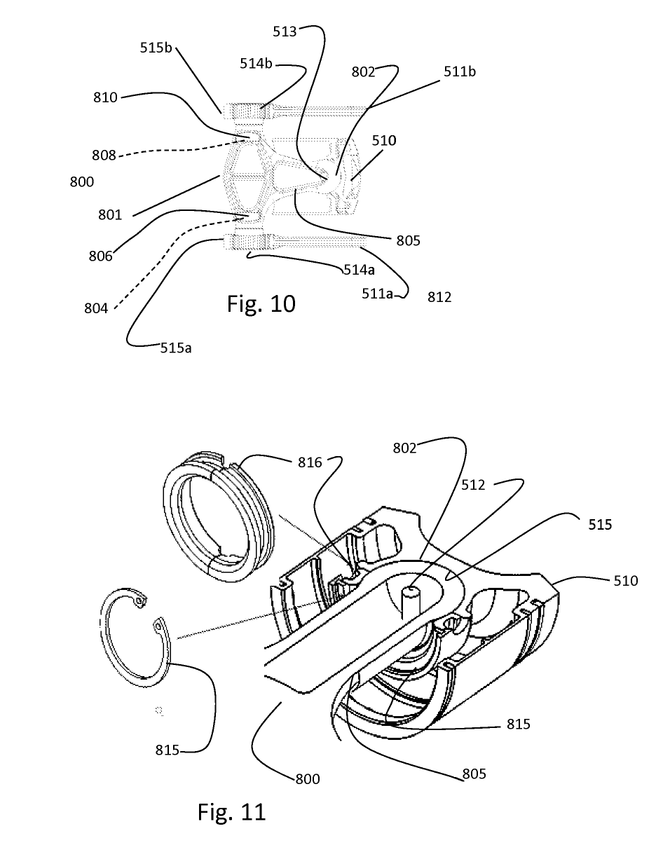

Guided bridge 800 is mounted for reciprocating movement in an extension cap 902 that connects to and forms part of engine housing 900. Guided bridge 800, in this embodiment, (see FIGS. 9 and 10) has a generally triangular shape with its base 801 being connected to the parallel pullrods 515a and 515b, and the a ball shaped nose 802 extending from the apex of the triangular shape along a projection 805. Bridge nose 802 is formed as a spherical ball for mating with a like hemispherical ball socket 512 in outer piston 510. The spherical mating of the bridge to the piston provides for point contact between those elements which in turn provides increased flexibility between the two to significantly reduce side forces being imposed onto the piston.

The base 801 of the triangular shaped guided bridge 800 has bosses 803a and 803b that extend outwardly along a horizontal axis “A-A” that is perpendicular to the cylinder axis. Bosses 803a and 803b fit within the races 507a and 507b of needle bearings 514a and 514b (FIG. 13) that are mounted in hubs 515a and 515b of pullrods 511a and 511b, respectively. The upper and lower surfaces 804/806 and 808/810 of the guided bridge 800 are ground smooth and serve as the contact points with respect to the lower and upper guide surfaces 904/906 and 908/910 formed in extension cap 902.

Extension cap 902 contains a central aperture 903; and two sets of opposing lower and upper guide surfaces 904/906 and 908/910 that serve as slide bearings. Guide surfaces 904/906 and 908/910 are parallel to the cylinder axis and the reciprocating directions of travel followed by piston 510 to form a guideway for the guided bridge 800. The material used for lower and upper guide surfaces 904/906 and 908/910 can be any low friction polished metal, ceramic or composite that provides long life in a wide range of environmental temperatures and from any caustic elements that may contaminate lubrication fluids. Extension cap 902 contains several intercommunicating passages that allow lubricating oil present in the housing 900 to be circulated to and directed onto the guideway surfaces to further reduce any friction that may otherwise contribute to side forces.

While the embodiment above is described as having guided bridge face surfaces to guide face surfaces as being smoothly ground or polished metal surfaces, it is because such surfaces can be formed very economically with significantly improved results compared to the prior art. However, it is appreciated that other low friction alloy, ceramic or plastic materials could be implanted into the opposing surfaces to have sliding surface contact if their low friction properties are suitable for improvements in this environment.

Outer piston 510 (FIGS. 10 and 11) is configured with a hemispherical ball socket 513 to receive the forward part of spherical bridge nose 802 and provide for a spherical contact between guided bridge 800 and outer piston 510. An expandable wear ring 816 and a snap ring are held in separate circular channels within the under cavity of piston 510 and surround projection 805, below bridge nose 802. Expandable wear ring 816 along with snap ring 815 function to keep the spherical socket 512 and bridge nose 802 connected during assembly and during the crank start prior to engine operation. Constant compression during engine operation serves to maintain the connection and no pressure is exerted on those elements during the operation. During the crank start period and prior to ignition, there are periods when the pull rods 511a and 511b draw the outer piston 510 outwards towards its bottom dead center position. That is when it is necessary for the piston 510 to be retained in contact with the bridge nose 802 on the guided bridge 800.

A pin 512 also serves to connect outer piston 510 to bridge nose 802. The pin is vertically oriented (perpendicular to the horizontal axis extending through bosses 803a and 803b in piston 510 and a vertically aligned hole 812 in guide bridge nose 802 (aligned perpendicular to the axis of cylinder 500).

When the pistons of left cylinder 500 enter their power stoke of the engine cycle, the expanding gases present on the face of piston 510 force the ball socket 512 against the bridge nose 802. Due to the interaction of the bosses 803a and 803b with the bearings 514a and 514b, and the resistance of the angled pull rods 511a and 511b, any side forces that are generated are directed between upper and lower surfaces 804/806 and 808/810 of guided bridge 800 to the corresponding lower and upper guide surfaces 904/906 and 908/910 while guided bridge 800 is sliding there along. As a result, almost all pullrod generated side forces are dissipated so as not to be fed back and effect the travel of outer piston 510.

When the pistons of left cylinder 500 enter their compression stoke of the engine cycle, pull rods 511a and 511b are again under tension and being pulled by the crank shaft 700. Pull rods 511a and 511b interact with guided bridge 800 through bearings 514a and 514b and bosses 803a and 803b to force the bridge nose 802 against socket 512. This action causes outer piston 510 to be pushed along the cylinder axis towards inner piston 520 against the resistance of air being compressed within the cylinder. Due to the interaction of the angled pull rods 511a and 511b through bearings 514a and 514b with bosses 803a and 803b and the resistance of outer piston 510, any side forces that are generated are directed between the upper and lower surfaces 804/806 and 808/810 of the guided bridge 800 to the corresponding lower and upper guide surfaces 904/906 and 908/910 while guided bridge 800 is sliding there along. Consequently almost all pullrod generated side forces are isolated from outer piston 510. As stated earlier, the reduction in side forces on the pistons of an internal combustion engine is highly desirable in order to reduce piston chafing or scuffing that may sometimes occur during operating conditions.

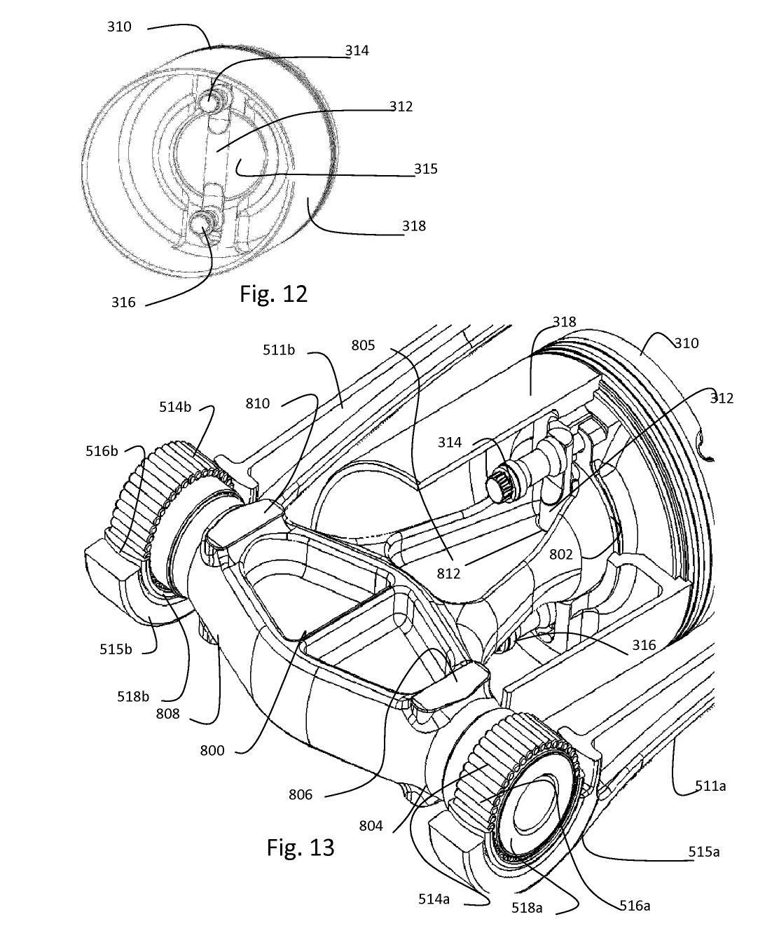

FIGS. 12 and 13 illustrate another piston configuration 310 in which a spherical socket 315 mates with bridge nose 802 on guided bridge 800. This piston differs from the earlier described piston 510 in the manner in which it is retained to guided bridge 800, In this case, a pin 312 is fastened to the underside of piston 310 by bolts 314 and 316 (or by other equivalent retaining devices). Pin 312 is fitted through vertical hole 812 in bridge nose 802 and held in place by bolts 314 and 316. Piston 310 provides for alternative connection means and may offer improvements in durability or assembly costs.

FIG. 13 also illustrates an improved bearing structure that may be employed in the present invention to further reduce undesired forces to the elements. In this case, the use of a spherical bearing race ring 518a and 518b inside pull rod hubs 515a and 515b provides added rotational flexibility. The circular inner surfaces of pull rod hubs 515a and 515b are spherically curved to accept race rings 518a and 518b having like outer circular surfaces that are also spherically curved. The mating spherical surfaces provide a spherical bearing that allows for minor rotation to occur between the bosses of guide 800 and the pull rods without creating bending torque on the pull rods. The inner surface of race rings 518a and 518b are planar to support the rotation of needle bearings 514a and 514b in a conventional fashion.

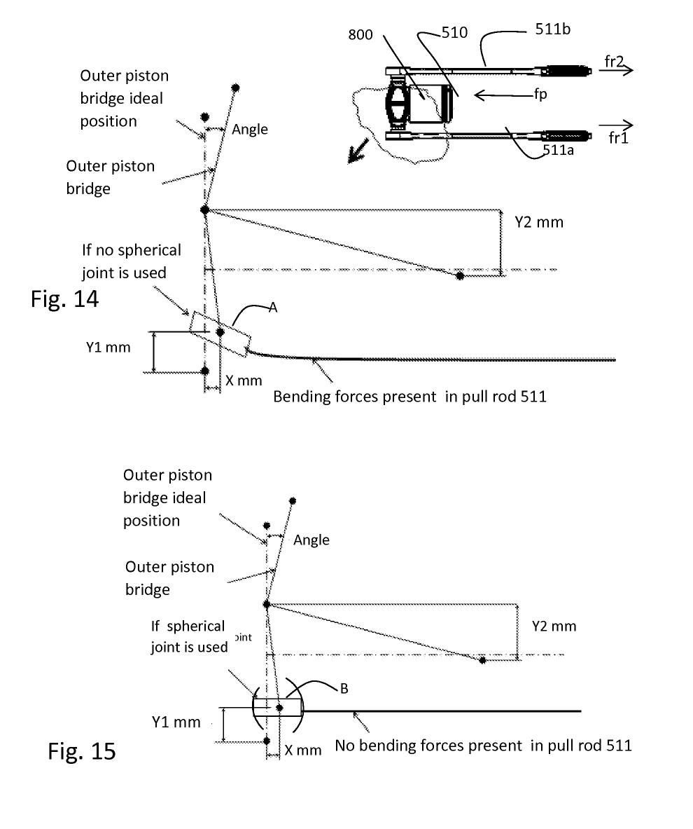

The function of the spherical bearing is illustrated with respect to the vector graphs of FIGS. 14 and 15. In FIG. 14, the condition without a spherical bearing is illustrated. In FIG. 15, the condition with a spherical bearing is illustrated. The vertical dashed line of both FIGS. 14 and 15 indicates the desired position of the guided bridge, i.e., continuously orthogonal to the cylinder axis. The angle represented in the upper portion of the vector graph illustrates an exaggerated deformation that could be exerted on the guided bridge during unusual operating load conditions.

In FIG. 14, without a spherical bearing, if such angular stress were to occur on the guided bridge and its bosses were thrown off-angle, the result would be a torque angle generated on the rod hobs at “A” that would cause slight bending and stress on the pull rods 511.

In contrast, FIG. 15 illustrates that if the guided bridge were to encounter the same stresses, the bosses would be able to rotate slightly within the rod hubs due the spherical bearing and not induce torque bending on the pull rods 511 at “B”

The embodiment shown and described herein is merely exemplary of various configurations that may be designed to exhibit the inventive concepts recited in the claims and is not intended to be restrictive.

1. An internal combustion engine having an engine housing in which a piston is mounted in a cylinder for reciprocating motion and said piston is connected to a crankshaft via a bridge element and at least one pull rod;
said bridge element is connected between said at least one pull rod and said piston to dissipate and prevent side forces from reaching said piston;
said bridge element is connected at one end to said at least one pull rod and pivoted along an axis that is perpendicular to the axis of said cylinder;
said bridge element is contains a remote second end that contacts the underside of said piston; and
said engine includes a housing and said housing provides a plurality of opposed sliding surfaces for guiding said bridge element for low friction sliding movement in a define guideway.

2. An engine as in claim 1, wherein said piston is connected to said crankshaft via a pair of pull rods and said bridge element is connected between said piston and said pair of pull rods.

3. An engine as in claim 2, wherein said bridge element is generally triangular in shape and has a set of bosses extending from ends of the base of said triangular shaped bridge element and a spherical ball shaped nose extending from the apex of said triangular shaped bridge element, and further wherein said ball shaped nose mates with a like spherical socket centrally located on the underside of said piston.

4. An engine as in claim 3, wherein said bridge element is configured to slide in generally horizontal directions along with said piston during a reciprocating operation and said bridge element contains upper and lower portions with slide bearing surface areas defined on each portion and said plurality of opposed sliding surfaces on said engine housing oppose and coincide with said bearing surface areas defined on said bridge element for guiding said bridge element in a define guideway during its reciprocating motion with said piston.

5. An engine as in claim 4, wherein said bosses of said bridge element are each connected to the end of a pull rod via a roller bearing to allow said pull rods to rotate with respect to said bosses.

6. An engine as in claim 5, wherein a spherical bearing is established between said ends of each pull rod and said roller bearings to allow low friction axial flexing between said bosses and said pull rods.

7. An engine as in claim 4, wherein said bearing surface areas on said bridge element and opposed sliding surfaces on said engine housing are formed of materials that provide low sliding friction when said bridge element is reciprocally moved with said piston.

8. An engine as in claim 7, wherein said engine housing provides passages that direct lubricating fluid onto said opposed bearing and sliding surfaces.

9. An engine as in claim 3, wherein said nose of said bridge element contains a hole that runs perpendicular to said axis of said cylinder and said piston socket contains a set of holes that coincide with each end of said bridge element nose hole, and a pin is located in all said holes to provide retention between said piston and said bridge element.

10. An engine as in claim 9, wherein said piston socket is hemispherical and said piston has a circular channel that extends from said socket and beyond said bridge element nose, and said circular channel accepts a snap ring that is sized to capture said bridge element nose and retain said bridge and piston as an assembly.

11. An engine as in claim 3, wherein said bridge element contains a hole that runs perpendicular to said axis of said cylinder and said piston socket is configured to retain a pin that extends through said bridge element nose hole to provide retention between said piston and said bridge.

12. An engine as in claim 11, wherein said piston is configured with threaded holes on its underside to receive bolts on opposite sides of said bridge element nose hole and said bolts secure the ends of said pin extending from said bridge element nose hole to said piston.

13. An engine as in claim 9, wherein said bridge element is configured to slide in generally horizontal directions along with said piston during the reciprocating operation and said bridge element nose hole runs orthogonal to said horizontal directions and said piston is allowed to have rotational movement about said pin.

14. An engine as in claim 11, wherein said bridge element is configured to slide in generally horizontal directions along with said piston during a reciprocating operation and said bridge element nose hole runs orthogonal to said horizontal directions and said piston is allowed to have rotational movement about said pin.

15. An engine as in claim 1, wherein each said pull rod is always under tension during engine operation.

16. An improved internal combustion engine having an engine housing, opposing left and right cylinders, a set of opposing inner and outer pistons disposed for reciprocating motion along a cylinder axis in each of said opposing left and right cylinders and at least one crankshaft, and each of said outer pistons are connected to said at least one crankshaft through a plurality of pull rods, wherein said improvement includes a bridge element that resides between each said outer piston and its corresponding pull rods to move in reciprocating directions along with said piston, said bridge element includes upper and lower surfaces containing defined slide bearing portions, said housing includes fixed opposed surfaces within said housing that extend in directions parallel to each cylinder axis to form a slide bearing guideway for sliding contact with said slide bearing portions of said bridge element to slide between, and said improvement further includes roller bearings between said pull rods and said bridge element.

17. An engine as in claim 16, wherein each said pull rod has a hub for retaining a set of said roller bearings and said roller bearings are mounted within an outer bearing race that has a planar inner surface in contact with said roller bearings and an outer spherical surface in contact with a corresponding spherical inner surface of said pull rod hub.

18. An improved engine as in claim 17, wherein said bridge element includes oppositely extending bosses that are each in contact with a set of said roller bearings and each said boss serves as the inner race for said roller bearings.

19. A method of reducing friction in an internal combustion engine in which a piston is mounted in a cylinder for reciprocating motion and said piston is connected to a crankshaft via at least one pull rod, comprising the steps of:
providing a bridge element for connection between the end of said at least one pull rod and said piston to dissipate and prevent side forces from reaching said piston;
connecting said bridge element to one end of said at least one pull rod to allow rotation pivoted along an axis that is perpendicular to the axis of said cylinder;
connecting said bridge element to the underside of said piston to allow said bridge element to move therewith; and
providing a plurality of opposed and fixed sliding surfaces within said housing for retaining said bridge element in a define low friction guideway.

20. A method as in claim 19, applied to an internal combustion engine in which said piston is connected to a pair of pull rods that are continually under tension during the engine operation.

21. An internal combustion engine having an engine housing in which a piston is mounted in a cylinder for reciprocating motion and said piston is connected to a crankshaft by a pair of pull rods;
means for interconnecting said pull rods and said piston; said interconnecting means containing first and second bosses that are axially aligned and oppositely extended for connection with respective ones of said pair of pull rods;
each pull rod has a hub with a partially spherical inner surface for retaining a set of roller bearings and said roller bearings are mounted within an outer bearing race that has a planar inner surface in contact with said roller bearings and an outer spherical surface in contact with a said partially spherical inner surface of said pull rod hub;
said oppositely extending first and second bosses contain cylindrical outer surfaces each in contact with a set of said pull rod roller bearings and each said boss serves as the inner race for said roller bearings.

22. An internal combustion engine as in claim 21, wherein said means for interconnecting is a bridge element.

23. An internal combustion engine having an engine housing, opposing left and right cylinders, a set of opposing inner and outer pistons disposed for reciprocating motion along a cylinder axis in each of said opposing left and right cylinders and at least one crankshaft, and each of said outer pistons are connected to said at least one crankshaft through a plurality of pull rods, means located between each said outer piston and a corresponding pair of pull rods for interconnecting said pull rods and said outer piston and for moving in reciprocating directions along with said piston, each pull rod having a hub with a partially spherical inner surface surrounding an separately extended portion of said interconnecting means and a set of roller bearings; said roller bearings being mounted within an outer bearing race that has a cylindrical inner surface in contact with said roller bearings and an outer spherical surface in contact with a said partially spherical inner surface of said pull rod hub; said separately extended portions of said interconnecting means each contain a cylindrical outer surface that is in contact with a set of said pull rod roller bearings and each said cylindrical outer surface serves as the inner race for said roller bearings.

24. An internal combustion engine as in claim 23, wherein said interconnecting means is a bridge element.
